(19) United States
(12) Patent Application Publication
(10) Pub. No.: US 2016/0300657 A1
(43) Pub. Date: Oct. 13, 2016

(54) INTEGRATED INDUCTOR AND INTEGRATED INDUCTOR MAGNETIC CORE OF THE SAME

(71) Applicant: DELTA ELECTRONICS, INC., Taoyuan City (TW)

(72) Inventors: Rui WU, Taoyuan City (TW); Jin-Ping ZHOU, Taoyuan City (TW); Yu ZHANG, Taoyuan City (TW); Jian-Hong ZENG, Taoyuan City (TW); Min ZHOU, Taoyuan City (TW)

(21) Appl. No.: 15/092,629

(22) Filed: Apr. 7, 2016

(30) Foreign Application Priority Data
Apr. 10, 2015 (CN) 201510169368.5
Jul. 27, 2015 (CN) 201510446385.9

(51) Int. Cl. H01F 27/24; H01F 27/28

(52) U.S. Cl. CPC H01F 27/24; H01F 27/2823

(57) ABSTRACT

An integrated inductor apparatus integrated to be a plurality of inductors is provided. The integrated inductor apparatus includes inductor windings to form inductors and includes at least two windows each having at least one of the inductor windings disposed therein and magnetic core units, each having a closed geometrical structure to form one of the at least two windows, wherein two of the neighboring magnetic core units have a shared magnetic core part. The magnetic core units comprise at least two kinds of material having different magnetic permeability corresponding to different sections of the magnetic core units, wherein the reluctance of the shared magnetic core part is smaller than the reluctance of a non-shared magnetic core part of the magnetic core units.

### RELATED APPLICATIONS

This application claims priority to China Application Serial Number 201510169368.5, filed Apr. 10, 2015 and China Application Serial Number 201510446385.9, filed Jul. 27, 2015, which are herein incorporated by reference.

### BACKGROUND

1. Field of Invention

The present disclosure relates to a power technology. More particularly, the present disclosure relates to an integrated inductor apparatus and an integrated magnetic core of the same.

2. Description of Related Art

In recent years, miniaturization of switching mode power supply is an important trend of the development of power technology. In a switching mode power supply, magnetic components occupy a certain degree of the volume and contribute a certain degree of the loss. Therefore, the design and improvement of the magnetic components become very important.

In some application scenarios, such as an application with large current condition, a plurality of paths of circuits connected in parallel are used to decrease the occurrence of the ripples. In common designs of the magnetic components, in order to guarantee the unsaturation and low loss of the material, the volume of the magnetic components has to be increased to decrease the strength of the magnetic induction in the magnetic core. As a result, it is a tradeoff between persuading high efficiency and persuading high power density.

Accordingly, what is needed is a switching mode power supply and an integrated device of the same to address the above issues.

### SUMMARY

An aspect of the present invention is to provide an integrated magnetic core, integrated with a plurality of inductor windings to form a plurality of inductors. The integrated magnetic core includes at least two windows and a plurality of magnetic core units. Each of the at least two windows has at least one of the inductor windings disposed therein. Each of the magnetic core units has a closed geometrical structure to form one of the at least two windows, wherein two of the neighboring magnetic core units have a shared magnetic core part. The magnetic core units include at least two kinds of material having different magnetic permeability corresponding to different sections of the magnetic core units, wherein the reluctance of the shared magnetic core part is smaller than the reluctance of a non-shared magnetic core part of the magnetic core units.

Yet another aspect of the present invention is to provide an integrated inductor apparatus to integrate a plurality of inductors. The integrated inductor apparatus includes a plurality of inductor windings and an integrated magnetic core integrated with the inductor windings to form the inductors. The integrated magnetic core includes at least two windows and a plurality of magnetic core units. Each of the at least two windows has at least one of the inductor windings disposed therein. Each of the magnetic core units has a closed geometrical structure to form one of the at least two windows, wherein two of the neighboring magnetic core units have a shared magnetic core part. The magnetic core units include at least two kinds of material having different magnetic permeability corresponding to different sections of the magnetic core units, wherein the reluctance of the shared magnetic core part is smaller than the reluctance of a non-shared magnetic core part of the magnetic core units.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a circuit diagram of a switching mode power supply in an embodiment of the present invention;

FIG. 2 is a diagram of the integrated inductor apparatus used in the multi-phase inductors in an embodiment of the present invention;

FIG. 3A is a diagram of the integrated inductor apparatus and a part of the magnetic flux therein in an embodiment of the present invention;

FIG. 3B is a three-dimensional diagram of partial magnetic core of the integrated magnetic core in an embodiment of the present invention;

FIG. 4 is a diagram of the integrated inductor apparatus used in the multi-phase inductors in an embodiment of the present invention;

FIG. 5 is a diagram of the integrated inductor apparatus used in the multi-phase inductors in an embodiment of the present invention;

FIG. 6A-FIG. 6G are diagrams of a single magnetic core unit respectively in an embodiment of the present invention;

FIG. 7A and FIG. 7B are diagrams of the integrated magnetic core in an embodiment of the present invention;

FIG. 8 is a diagram of the integrated magnetic core in an embodiment of the present invention;

FIG. 9 is a diagram of the integrated magnetic core in an embodiment of the present invention;

FIG. 10 is a diagram of the integrated magnetic core in an embodiment of the present invention;

FIG. 11 is a diagram of the integrated magnetic core in an embodiment of the present invention;

FIG. 12 is a diagram of the integrated magnetic core in an embodiment of the present invention;

FIG. 13 is a diagram of the integrated magnetic core in an embodiment of the present invention;

FIG. 14A is a diagram of the integrated magnetic core in an embodiment of the present invention;

FIG. 14B is a diagram of the manufactured structure of the integrated magnetic core illustrated in FIG. 14A in an embodiment of the present invention;

FIG. 15A is a diagram of the integrated magnetic core in an embodiment of the present invention;

FIG. 15B is a diagram of the manufactured structure of the integrated magnetic core illustrated in FIG. 15A in an embodiment of the present invention;

FIG. 15C is a diagram of the integrated magnetic core in an embodiment of the present invention;

FIG. 15D is a diagram of the integrated magnetic core in an embodiment of the present invention;

FIG. 15E is a diagram of a top cover in an embodiment of the present invention;

FIG. 15F is a diagram of a magnetic path model of the magnetic core unit in an embodiment of the present invention;

FIG. 15G is a diagram of a magnetic path model of the magnetic core unit in an embodiment of the present invention;

FIG. 15H is a diagram of a magnetic path model of the magnetic core unit in an embodiment of the present invention; and

FIG. 15I is a diagram of a magnetic path model of the magnetic core unit in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In embodiments, the integrated inductor apparatus may be multi-phase inductors.

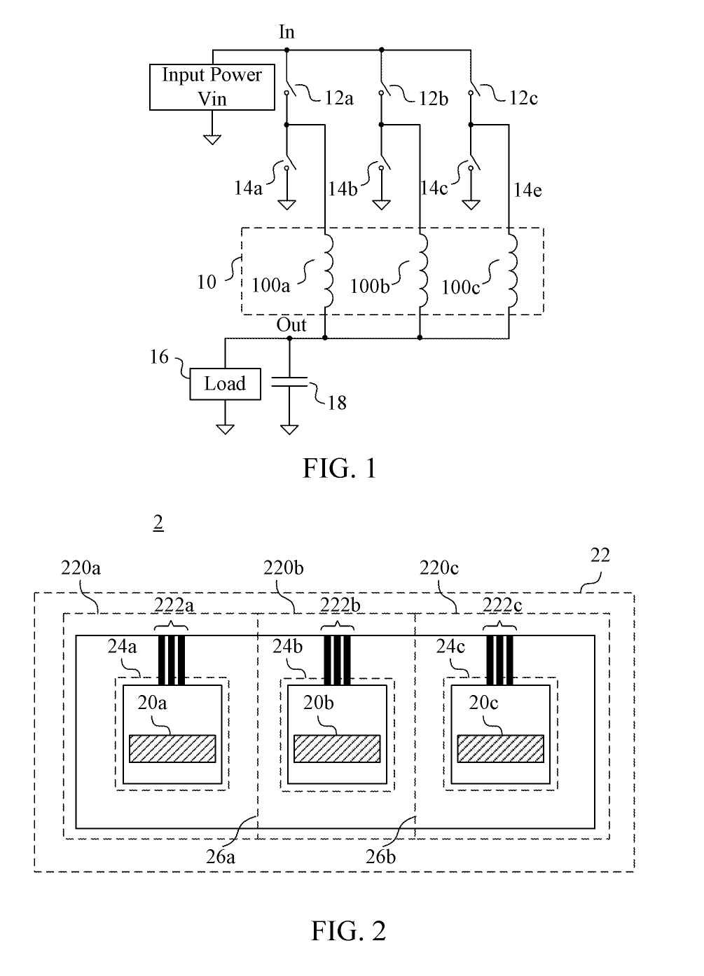

Reference is now made to FIG. 1. FIG. 1 is a circuit diagram of a switching mode power supply 1 in an embodiment of the present invention. The switching mode power supply 1 includes multi-phase inductors 10, a plurality transistors 12a-12c and 14a-14c and load 16.

The multi-phase inductors 10 are electrically connected to a common output terminal OUT of the switching mode power supply 1. As a result, the multi-phase inductors 10 are the output inductors corresponding to the common output terminal OUT of the switching mode power supply 1. The multi-phase inductors 10 include a plurality of inductors 100a-100c.

The transistors 12a-12c and the corresponding transistors 14a-14c form a plurality of power conversion circuits connected in parallel. The common output terminal OUT is the output of the power conversion circuits. In the present embodiment, as illustrated in FIG. 1, each of the inductors 100a-100c is electrically connected to the corresponding transistors 12a-12c and 14a-14c. Taking the inductor 100a as an example, the inductor 100a is electrically connected to the transistors 12a and 14a. The inductors 100a-100c are further connected to a common input terminal IN. In the present embodiment, the common input terminal IN receives an input voltage Vin.

The load 16 is electrically connected to the multi-phase inductors 10 at the common output terminal OUT. In an embodiment, the switching mode power supply 1 further includes other load components, such as but not limited to the capacitor 18 illustrated in FIG. 1 to stabilize the circuit.

It is appreciated that the disposition of the multi-phase inductors 10 in the switching mode power supply 1 is merely an example. In other embodiments, the multi-phase inductors 10 can be directly electrically connected to the common input terminal IN to become input inductors and are electrically connected to the common output terminal OUT through the transistors.

The multi-phase inductors 10 can be implemented by an integrated inductor apparatus 2 illustrated in FIG. 2. Reference now is made to FIG. 2. FIG. 2 is a diagram of the integrated inductor apparatus 2 used in the multi-phase inductors 10 in an embodiment of the present invention. The integrated inductor apparatus 2 includes a plurality of windings 20a-20c and an integrated magnetic core 22. The windings 20a-20c and the integrated magnetic core 22 form the inductors 100a-100c illustrated in FIG. 1.

The number of the windings 20a-20c is corresponding to the number of the inductors 100a-100c in the multi-phase inductors 10 illustrated in FIG. 1. In an embodiment, the windings 20a-20c includes a copper sheet, a litz wire, a PCB winding, a circular conductor or a bunched conductor. In an embodiment, the current directions of the windings 20a-20c are the same and have a predetermined phase difference, for example, 60 degrees, 120 degrees, or 180 degrees.

In the present embodiment, the integrated magnetic core 22 includes three magnetic core units 220a-220c. The magnetic core units 220a-220c include the corresponding windows 24a-24c. Each of the magnetic core units 220a-220c has a closed geometrical structure to form one of the windows 24a-24c.

As illustrated in FIG. 2, the closed geometrical structure of each of the magnetic core units 220a-220c is a quadrangle. The magnetic core unit 220a corresponds to the window 24a. The magnetic core unit 220b corresponds to the window 24b. The magnetic core unit 220c corresponds to the window 24c. The window 24a includes the winding 20a. The window 24b includes the winding 20b. The window 24c includes the winding 20c. Two of the neighboring magnetic core units have a shared magnetic core part. For example, the magnetic core units 220a and 220b have a shared magnetic core part 26a; the magnetic core units 220b and 220c have a shared magnetic core part 26b.

The magnetic core units 220a-220c includes at least two kinds of material having different permeability. In each magnetic core unit, the reluctance of shared part of magnetic core is smaller than that of the non-shared part. Taking the magnetic core units 220a and 220b as an example, the reluctance of the shared magnetic core part 26a is smaller than the reluctance of the non-shared magnetic core part of the magnetic core units 220a and 220b.

In an embodiment, the shared magnetic core part 26a is fabricated by using the material having the permeability higher than the permeability of the non-shared magnetic core part such that the reluctance of the shared magnetic core part 26a is smaller than the reluctance of the non-shared magnetic core part.

In another embodiment, at least part of non-shared magnetic core part in the magnetic core units 220a-220c, i.e., sections 222a-222c, includes a kind of material with lowest permeability among all kinds of material in the magnetic core units 220a-220c, to ensure the reluctance of the non-shared magnetic core part is larger than that of the shared part. For convenience, the kind of material with lowest permeability in non-shared part of magnetic core is called a first material in the application, and thus sections 222a-222c are first material sections. In an embodiment, the permeability of the first material of sections 222a-222c may be lower than or equal to 50. In an embodiment, sections 222a-222c are air gaps and the first material is air.

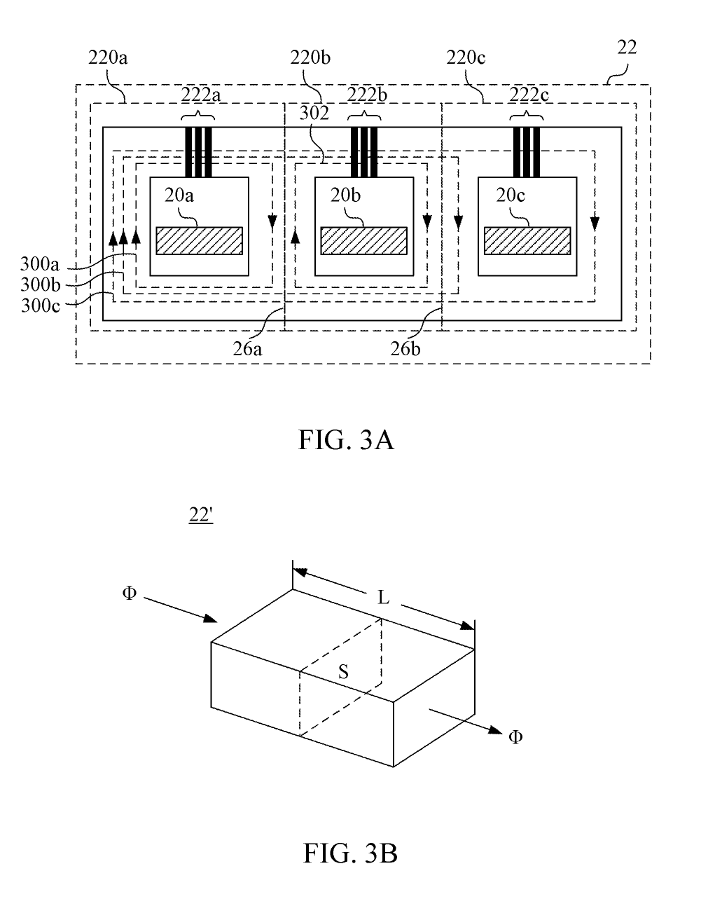

Reference is now made to FIG. 3A-3B at the same time. FIG. 3A is a diagram of the integrated inductor apparatus 2 and magnetic flux therein in an embodiment of the present invention. FIG. 3B is a three-dimensional diagram of partial magnetic core 22′ of the integrated magnetic core 22 in an embodiment of the present invention.

As illustrated in FIG. 3A, the windings 20a generates three magnetic fluxes 300a-300c in the integrated magnetic core 22. The magnetic flux 300a surrounds the magnetic core unit 220a, the magnetic flux 300b surrounds the magnetic core units 220a and 220b and the magnetic flux 300c surrounds the magnetic core units 220a-220c.

The magnitude of each of the magnetic flux is calculated according to the reluctance. Taking a section of the integrated magnetic core 22′ illustrated in FIG. 3B having a cross-sectional area S and a length L as an example, the direction of the magnetic flux Φ is the direction indicated by an arrow in the figure, the reluctance Rm is expressed as Rm=L/(u*S). In this equation, u=ur*u0, in which u0 is the vacuum permeability, ur is the relative permeability of the material used by the section of the integrated magnetic core 22′.

As a result, the magnetic flux 300a in FIG. 3A passes through one first material section 222a. The magnetic flux 300b passes through two first material sections 222a and 222b. The magnetic flux 300c passes through three first material sections 222a, 222b and 222c. As the reluctance of shared part magnetic core is smaller than that of the non-shared part, flux 300a is much larger than the flux 300b and 300c and becomes the main flux that generated by winding 20a, which means only a little part of flux generated by winding 20a is coupled to winding 20b and 20c.

Similarly, the winding 20b also generates three magnetic flux in the integrated magnetic core 22, wherein only the main magnetic flux 302 corresponding to the magnetic core unit 220b is exemplarily illustrated in FIG. 3A.

The two of the neighboring magnetic core units 220a and 220b generate direct current magnetic fluxes with opposite directions at the shared magnetic core part 26a, such as the magnetic flux 300a and 302 illustrated in FIG. 3A.

Such a design would cancel the direct current magnetic flux in the shared part of magnetic core 22 such that the core loss of the integrated inductor apparatus decreases. Further, due to magnetic core part 26a shared by the neighboring magnetic core units 220a and 220b, the whole size of the integrated magnetic core 22 can be shrunk. Relatively, in order to prevent the inductor from saturation, the material of the non-shared magnetic core part has a high reluctance relative to the shared magnetic core part 26a. Meantime, the low reluctance of the shared part magnetic core ensures the non-coupled integration of multiphase inductor.

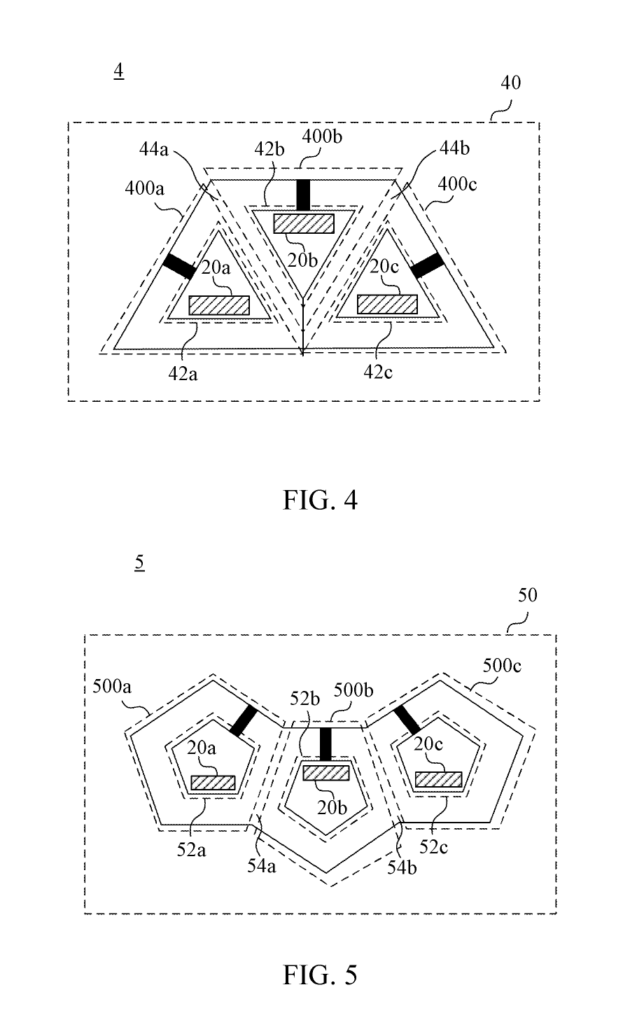

Reference is now made to FIG. 4. FIG. 4 is a diagram of the integrated inductor apparatus 4 in an embodiment of the present invention. The integrated inductor apparatus 4 includes a plurality of windings 20a-20c and an integrated magnetic core 40.

In the present embodiment, the integrated magnetic core 40 includes three magnetic core units 400a-400c. The magnetic core units 400a-400c include the corresponding windows 42a-42c. The windings 20a-20c are disposed in the windows 42a-42c respectively. The closed geometrical structure of each of the magnetic core units 400a-400c is a triangle. The magnetic core units 400a and 400b have a shared magnetic core part 44a. The magnetic core units 400b and 400c have a shared magnetic core part 44b. As described in the previous embodiments, the shared magnetic core parts 44a and 44b can be fabricated by the material having a higher initial permeability as compared to the non-shared magnetic core part to have a lower reluctance. Of course in the present embodiment, two columns of the magnetic core unit 400b are the shared magnetic core parts 44a and 44b respectively.

Reference is now made to FIG. 5. FIG. 5 is a diagram of the integrated inductor apparatus 5 in an embodiment of the present invention. The integrated inductor apparatus 5 includes a plurality of windings 20a-20c and an integrated magnetic core 50.

In the present embodiment, the integrated magnetic core 50 includes three magnetic core units 500a-500c. The magnetic core units 500a-500c include the corresponding windows 52a-52c. The windings 20a-20c are disposed in the windows 52a-52c respectively. The closed geometrical structure of each of the magnetic core units 400a-400c is a pentagon. The magnetic core units 500a and 500b have a shared magnetic core part 54a. The magnetic core units 500b and 500c have a shared magnetic core part 54b. As described in the previous embodiments, the shared magnetic core parts 54a and 54b can be fabricated by the material having a higher initial permeability as compared to the non-shared magnetic core part to have a lower reluctance.

In other embodiments, the number and the shape of the closed geometrical structure of the magnetic core units of the integrated magnetic core can be adjusted according to practical applications and are not limited to the number and the shape described in the above embodiments.

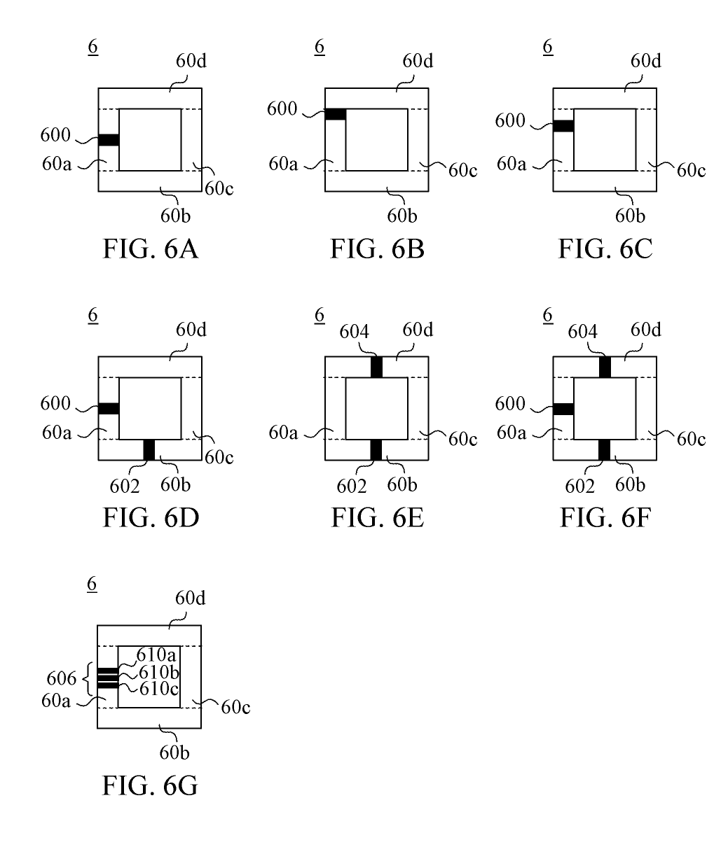

Reference is now made to FIG. 6A-FIG. 6G. FIG. 6A-FIG. 6G are diagrams of a single magnetic core unit 6 respectively in an embodiment of the present invention.

In the present embodiment, the closed geometrical structure of the magnetic core unit 6 is a quadrangle that includes four edges 60a, 60b, 60c and 60d. In an embodiment, the edge 60c is shared by other magnetic core units (not illustrated). As a result, on the non-shared magnetic core parts such as the edges 60a, 60b and 60d, the first material sections can be disposed. The disposition method of the first material sections, such as the number and the position of the first material sections, can be adjusted based on different requirements.

Taking FIG. 6A as an example, the first material section 600 is an air gap disposed at the center of the edge 60a. In FIG. 6B, the first material section 600 is disposed at one terminal of the edge 60a. In FIG. 6C, the first material section 600 including a single air gap is disposed at a quarter of length of the edge 60a relative to one terminal of the edge 60a.

In FIG. 6D, the first material sections 600 and 602 each including a single air gap are disposed at the centers of the edges 60a and 60b respectively. In FIG. 6E, the first material sections 602 and 604 each including a single air gap are disposed at the centers of the edges 60b and 60d respectively. In FIG. 6F, the first material sections 600, 602 and 604 each including a single air gap are disposed at the centers of the edges 60a, 60b and 60d respectively.

The first material sections mentioned in the above embodiments are examples of discretely disposing the first material sections on the magnetic core units.

In FIG. 6G, the first material section 606 including three air gaps 610a, 610b and 610c are disposed at the center of the edge 60a. In the present embodiment, the first material section is the example of intensively disposing the first material sections on the magnetic core units.

It is appreciated that various combinations of the positions and the numbers of the first material sections and the numbers of the air gap included in the first material sections mentioned above can be used according to different conditions and are not limited thereto. Surely, the air gap in the first material sections can also be stuffed by other material having a low permeability.

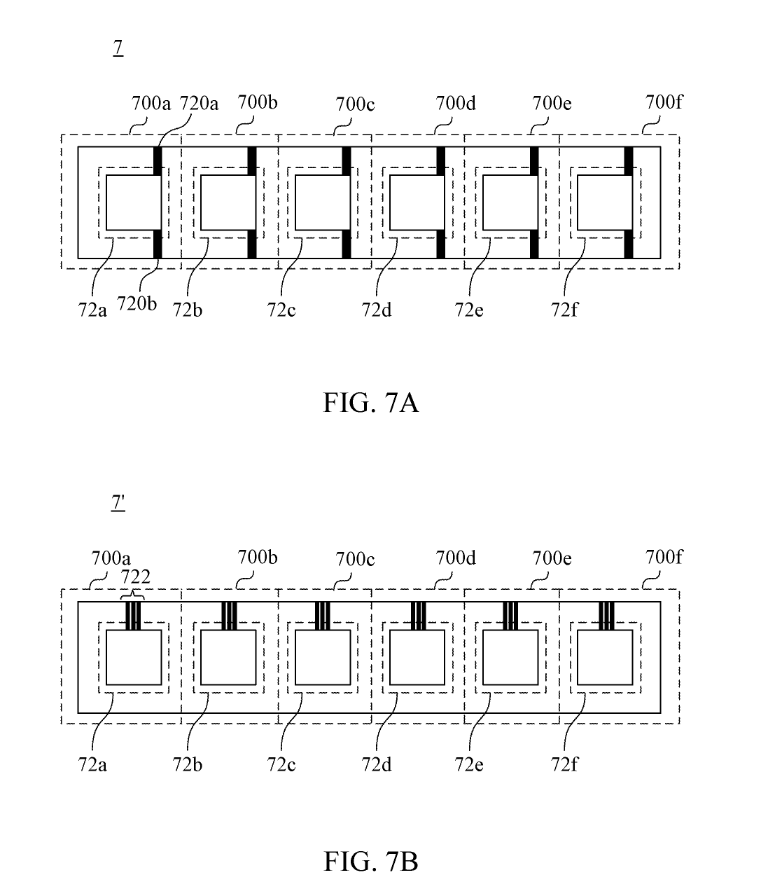

FIG. 7A and FIG. 7B are diagrams of the integrated magnetic core 7 in an embodiment of the present invention.

In the present embodiment, the integrated magnetic core 7 includes six magnetic core units 700a-700f and corresponding windows 72a-72f. The closed geometrical structure of each of the magnetic core units 700a-700f is a quadrangle. In the present embodiment, the axes of the windows of the illustrated integrated magnetic core 7 are parallel to each other.

Each of the magnetic core units 700a-700f includes at least one first high magnetic resistance material section. In FIG. 7, each of the magnetic core units 700a-700f includes two first high magnetic resistance material sections each having a single air gap and each disposed at a terminal of a corresponding edge, such as the first high magnetic resistance material section 720a and 720b corresponding to the magnetic core unit 700a. In FIG. 7B, each of the magnetic core units 700a-700f includes a plurality first high magnetic resistance material sections intensively disposed at the center of the corresponding edge, such as the first high magnetic resistance material section 722 corresponding to the magnetic core unit 700a.

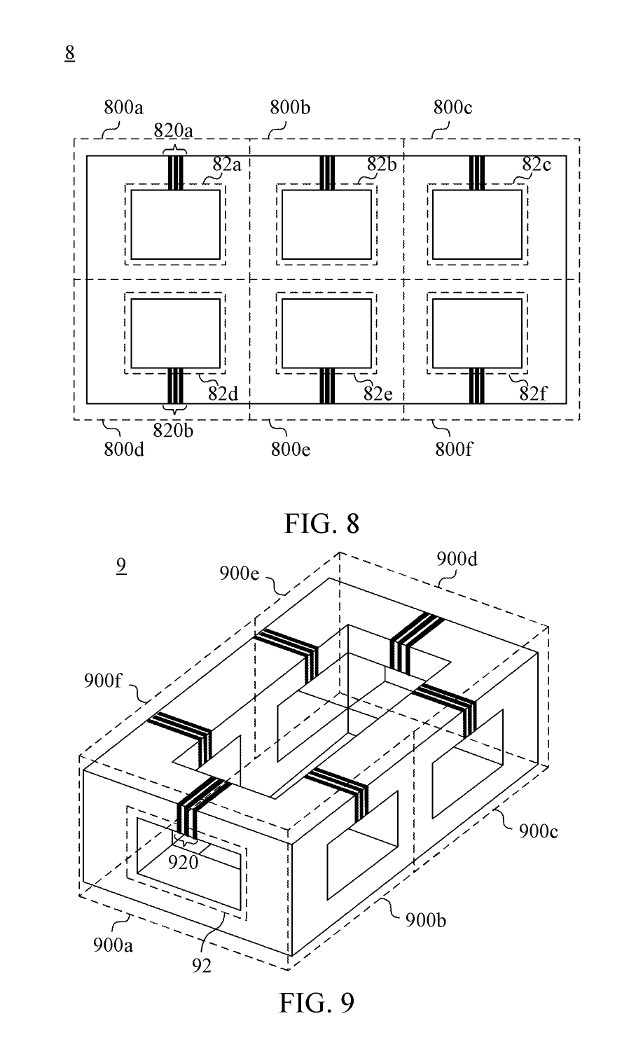

FIG. 8 is a diagram of the integrated magnetic core 8 in an embodiment of the present invention.

In the present embodiment, the integrated magnetic core 8 includes six magnetic core units 800a-800f and corresponding windows 82a-82f. The closed geometrical structure of each of the magnetic core units 800a-800f is a quadrangle. In the present embodiment, each of the magnetic core units 800a-800f has two or more than two neighboring magnetic core units connected thereto. Taking the magnetic core unit 800a as an example, the magnetic core unit 800a has two neighboring magnetic core units 800b and 800d connected thereto. The magnetic core unit 800b has three neighboring magnetic core units 800a, 800c and 800e connected thereto.

Each of the magnetic core units 800a-800c includes a plurality of first material sections disposed intensively at the center of the same side of the edges, such as the first material section 820a corresponding to the magnetic core unit 800a. Each of the magnetic core units 800d-800f includes a plurality of first material sections disposed intensively at the center of the same side of the edges, such as the first material section 820b corresponding to the magnetic core unit 800d.

As a result, the magnetic core units 800a-800f included in the integrated magnetic core 8 have more shared parts to shrink the size of the integrated magnetic core 8 more efficiently.

FIG. 9 is a diagram of the integrated magnetic core 9 in an embodiment of the present invention.

In the present embodiment, the integrated magnetic core 9 includes six magnetic core units 900a-900f and corresponding windows, such as the window 92 corresponding to the magnetic core unit 900a. The closed geometrical structure of each of the magnetic core units 900a-900f is a quadrangle. In the present embodiment, each of the magnetic core units 900a-900f has two neighboring magnetic core units connected thereto to form a cubic. Taking the magnetic core unit 900a as an example, the magnetic core unit 900a has two neighboring magnetic core units 900b and 900f connected thereto. The magnetic core unit 900c has two neighboring magnetic core units 900b and 900d connected thereto.

Each of the magnetic core units 900a-900f includes a plurality of first material sections disposed at the center of the same side of the edges, such as the first material section 920 corresponding to the magnetic core unit 900a.

As a result, the magnetic core units 900a-900f included in the integrated magnetic core 9 together form a cubic to shrink the size of the integrated magnetic core 9 more efficiently.

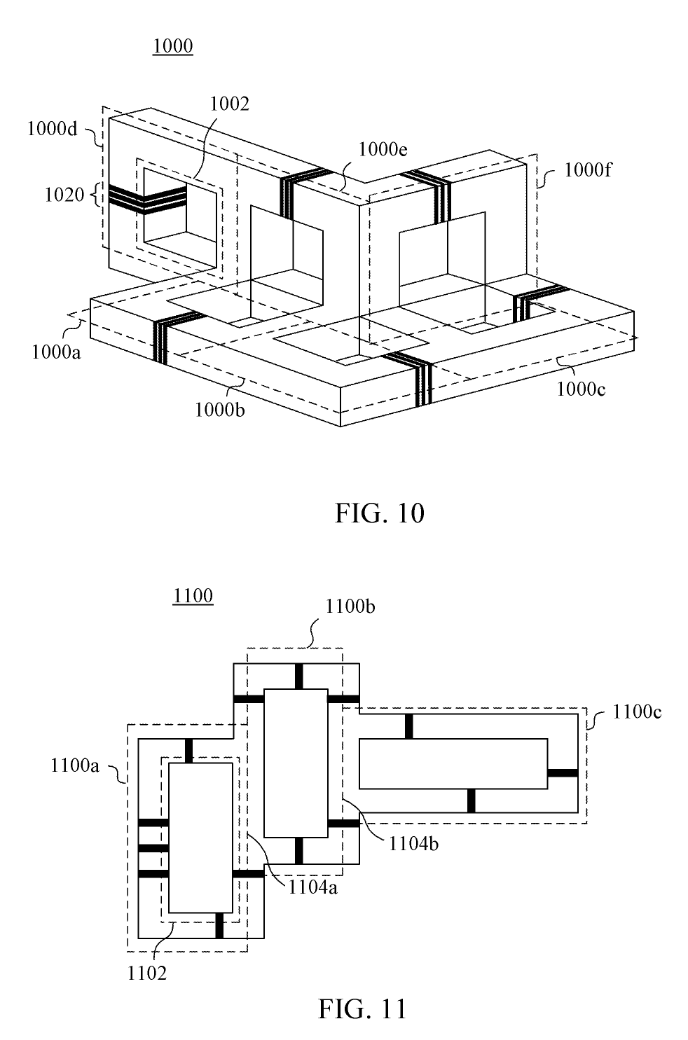

FIG. 10 is a diagram of the integrated magnetic core 1000 in an embodiment of the present invention.

In the present embodiment, the integrated magnetic core 1000 includes six magnetic core units 1000a-1000f and corresponding windows, such as the window 1002 corresponding to the magnetic core unit 1000d. The closed geometrical structure of each of the magnetic core units 1000a-1000f is a quadrangle. In the present embodiment, the magnetic core units 1000a-1000c are on the same plane, and the magnetic core unit 1000b has the neighboring magnetic core units 1000a and 1000c connected thereto. The magnetic core units 1000d-1000f are all on another plane, and the magnetic core unit 1000e has the neighboring magnetic core units 1000b and 1000f connected thereto. The magnetic core units 1000e and 1000f are respectively connected to the magnetic core units 1000a and 1000c.

The magnetic core units 1000a-1000c and the magnetic core units 1000d-1000f are vertical to each other. As a result, the axes of the windows that the magnetic core units 1000a-1000c and the magnetic core units 1000d-1000f corresponding to are vertical to each other to form an irregular three-dimensional shape.

In the present embodiment, each of the magnetic core units 1000a-1000f includes a plurality of first material sections disposed at the center of each one of the edges, such as the first material section 1020 corresponding to the magnetic core unit 1000d illustrated in FIG. 10.

As a result, the magnetic core units 1000a-1000f included in the integrated magnetic core 1000 can form an irregular three-dimensional shape according to the practical requirements.

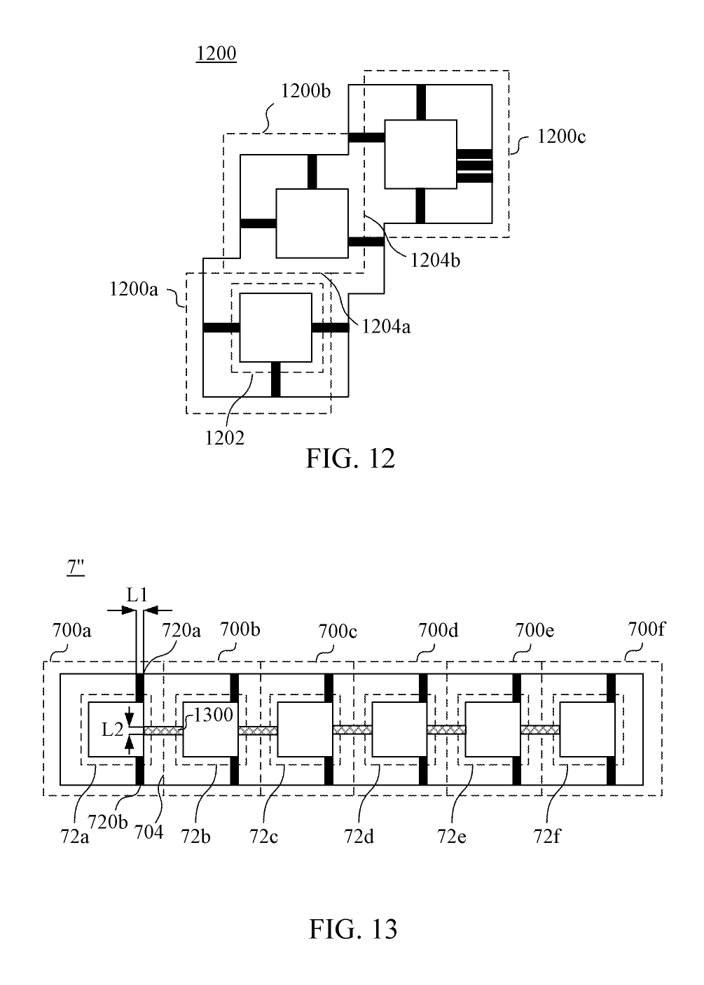

FIG. 11 is a diagram of the integrated magnetic core 1100 in an embodiment of the present invention.

In the present embodiment, the integrated magnetic core 1100 includes three magnetic core units 1100a-1100c and corresponding windows, such as the window 1102 corresponding to the magnetic core unit 1100a. The closed geometrical structure of each of the magnetic core units 1100a-1100c is a rectangle. In the present embodiment, a magnetic core part 1104a is partially shared by the edges of the magnetic core units 1100a and 1100b. A magnetic core part 1104b is partially shared by the edges of the magnetic core units 1100b and 1100c.

Further, various combination of the numbers and the positions of the first material sections included in the magnetic core units 1100a-1100c can be used. It is appreciated that though some of the edges of the magnetic core units 1100a-1100c include the shared magnetic core parts 1104a and 1104b, the first material sections can still be formed on the non-shared part of these edges.

As a result, the edges of the magnetic core units 1100a-1100c included in the integrated magnetic core 1100 can be formed with a partially shared manner according to the practical requirements.

FIG. 12 is a diagram of the integrated magnetic core 1200 in an embodiment of the present invention.

In the present embodiment, the integrated magnetic core 1200 includes three magnetic core units 1200a-1200c and corresponding windows, such as the window 1202 corresponding to the magnetic core unit 1200a. The closed geometrical structure of each of the magnetic core units 1200a-1200c is a rectangle. In the present embodiment, a magnetic core part 1204a is partially shared by the edges of the magnetic core units 1200a and 1200b. A magnetic core part 1204b is partially shared by the edges of the magnetic core units 1200b and 1200c.

Further, various combination of the numbers and the positions of the first material sections included in the magnetic core units 1200a-1200c can be used. It is appreciated that though some of the edges of the magnetic core units 1200a-1200c includes the shared magnetic core parts 1204a and 1204b, the first material sections can still be formed on the non-shared part of these edges.

As a result, the edges of the magnetic core units 1200a-1200c included in the integrated magnetic core 1200 can be formed with a partially shared manner according to the practical requirements.

FIG. 13 is a diagram of the integrated magnetic core 7″ in an embodiment of the present invention.

In the present embodiment, the integrated magnetic core 7″ is similar to the integrated magnetic core 7 illustrated in FIG. 7 and includes six magnetic core units 700a-700f and corresponding windows 72a-72f. The closed geometrical structure of each of the magnetic core units 700a-700f is a quadrangle. Each of the magnetic core units 700a-700f includes two first high magnetic resistance material sections each having a single air gap and each being disposed at one terminal of the corresponding edge, such as the first high magnetic resistance material sections 720a and 720b corresponding to the magnetic core unit 700a.

However, in the present embodiment, taking the shared magnetic core part 704 of the magnetic core units 700a and 700b as an example, the shared magnetic core part 704 includes a section with a second low permeability material. Such a section with low permeability material in shared part is named second material section. As a result, in an embodiment, when the permeability of the first material of the non-shared magnetic core unit 700a section 720a is U1, the permeability of the other parts of the non-shared magnetic core unit 700a is U3, the permeability of the second material section 1300 of the shared part is U2, the permeability of the other part of the shared part is U4, U4 is larger than U2, and U3 is larger than U1. If the cross-sectional area and the length of the non-shared part of the magnetic core unit 700a are S1 and L1, and the cross-sectional area and the length of the shared magnetic core part 704 are S2 and L2, the reluctance Rm1 of the non-shared part would be (2*L1)/(U1*S1) under the condition that U3 is far larger than U1. The reluctance Rm2 of the shared magnetic core part 704 would be L2/(U2*S2) under the condition that U4 is far larger than U2. After the adjustment of the lengths L1 and L2 and the cross-sectional areas S1 and S2, the reluctance Rm2 of the shared magnetic core part 704 can be smaller than the reluctance Rm1 of the non-shared part.

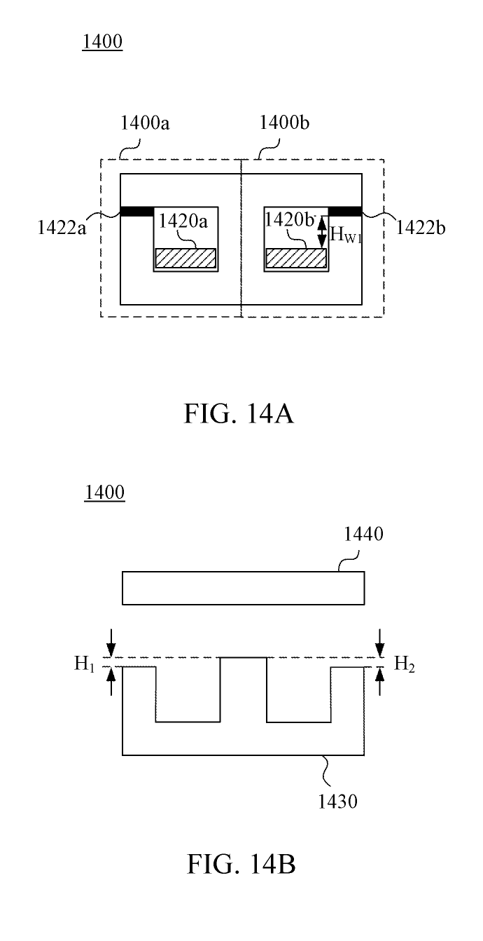

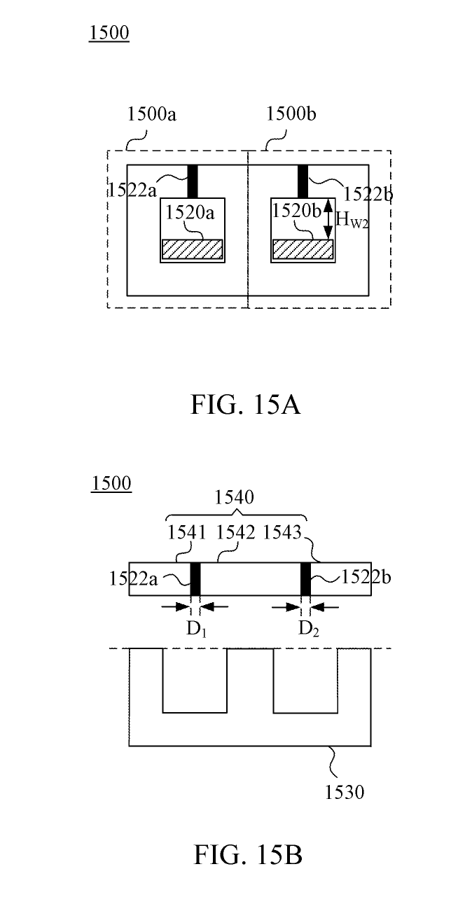

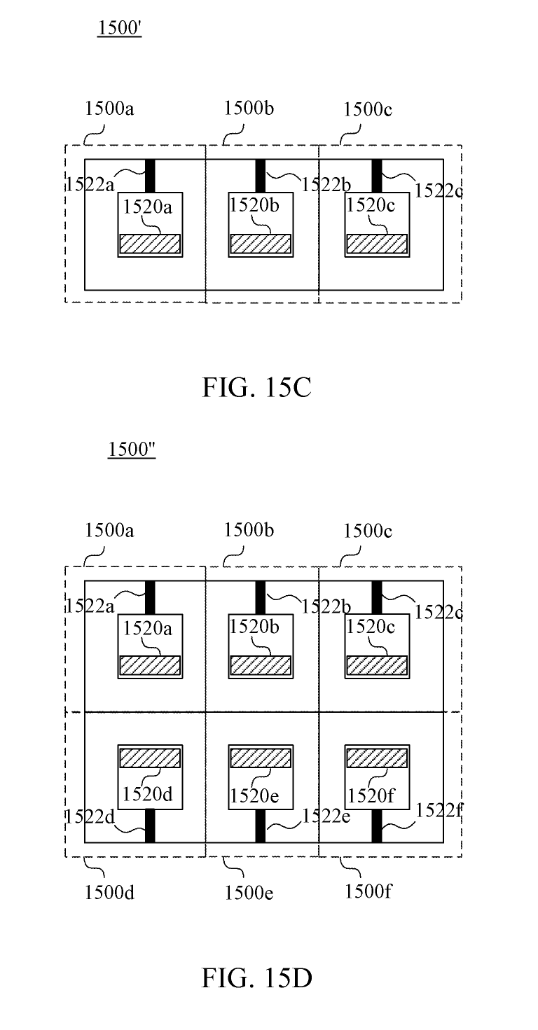

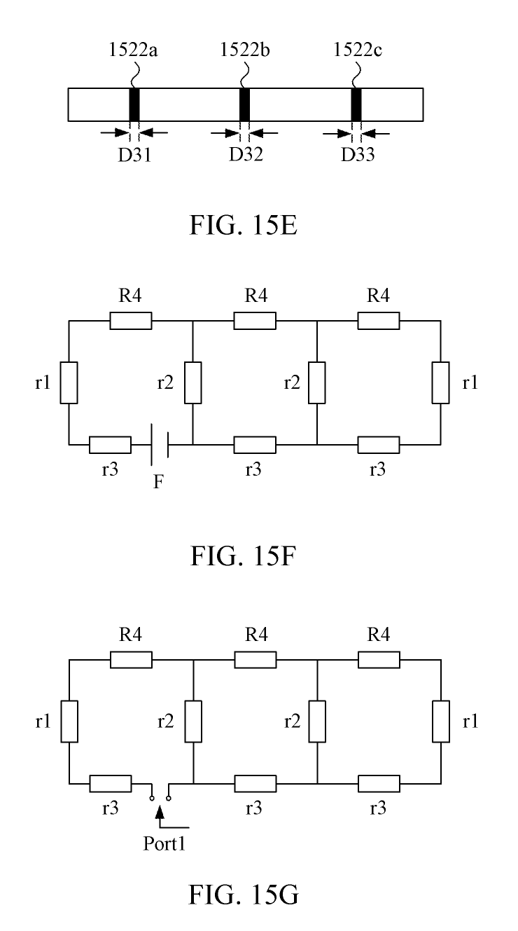

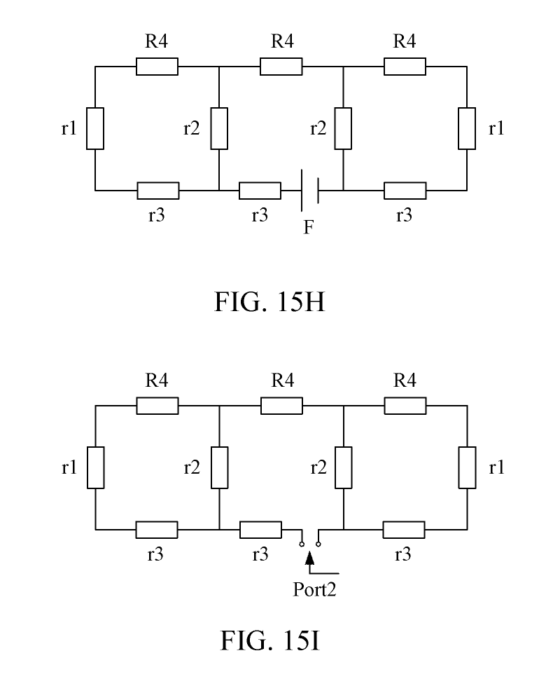

FIG. 14A is a diagram of the integrated magnetic core 1400 in an embodiment of the present invention. FIG. 15A is a diagram of the integrated magnetic core 1500 in an embodiment of the present invention.

In the embodiment illustrated in FIG. 14A, the integrated magnetic core 1400 includes two magnetic core units 1400a-1400b and corresponding windows that further include the corresponding inductor windings 1420a and 1420b. The magnetic core units 1400a-1400b include first material sections 1422a and 1422b respectively. In the embodiment illustrated in FIG. 15A, the integrated magnetic core 1500 includes two magnetic core units 1500a-1500b and corresponding windows that further include the corresponding inductor windings 1520a and 1520b. The magnetic core units 1500a-1500b include a first material sections 1522a and 1522b respectively.

FIG. 14B is a diagram of the manufactured structure of the integrated magnetic core 1400 illustrated in FIG. 14A in an embodiment of the present invention.

In order to manufacture the integrated magnetic core 1400 in FIG. 14A, the implementation is realized by fabricating the magnetic core base 1430 and the magnetic core top cover 1440 illustrated in FIG. 14B respectively. The vertical distances of the pillars of the two sides of the magnetic core base 1430 relative to the magnetic core top cover 1440 are H1 and H2 respectively. In order to keep the inductance of the two inductors identical to each other, it may be necessary to keep H1=H2. Since the top surfaces of the side pillars and the top surface of the middle pillar are not at the same plane, the polishing of the side pillars has to be performed by two steps, which easily results in the inequality between H1 and H2 due to the tolerances of the manufacturing of the magnetic core. In order to minimize the difference between H1 and H2, the subsequent polishing of the top surfaces of the side pillars is required. It is more difficult to control the accuracy in such a method.

FIG. 15B is a diagram of the manufactured structure of the integrated magnetic core 1500 illustrated in FIG. 15A in an embodiment of the present invention.

In order to manufacture the integrated magnetic core 1500 in FIG. 15A, the implementation is realized by fabricating the magnetic core base 1530 and the magnetic core top cover 1540 illustrated in FIG. 15B respectively. The heights of the side pillars and the middle pillar of the magnetic core base 1530 are the same. By polishing the three surfaces at the same time, the inequality of the pillars during the fabrication of the magnetic core can be solved to keep the heights thereof same. Further, the magnetic core top cover 1540 is formed by adhering the magnetic cores 1541, 1542 and 1543 with glue. In order to keep the inductance of the two inductors the same, the widths D1 and D2 of the first material sections 1522a and 1522b of the magnetic core top cover 1540 needs to be controlled to be identical to each other. In another method, spherical particles that are nonconductive and nonmagnetic insulator and have a diameter of D1 are mixed in the binder to fix the distance between the parts to be adhered in the magnetic core. The consistency of the inductance of the inductors is increased.

In order to follow the principle of sharing the magnetic cores, the first section can be disposed at any place of the non-shared magnetic core part. Therefore, different shapes of the magnetic core can be formed when a multiple of magnetic cores are shared. In combination with FIG. 14B, the first material sections 1422a and 1422b illustrated in FIG. 14A are disposed at the connection part of pillars of the magnetic core base 1430 and the magnetic core top cover 1440 of the integrated magnetic core 1400. In FIG. 15A, the first material sections 1522a and 1522b are disposed at the magnetic core top cover 1540. Though the two magnetic cores are equivalent from the point of view of the magnetic path, the implementations of the fabrication are different. As a result, the integrated magnetic core 1500 having the first material sections 1522a and 1522b disposed at the magnetic core top cover 1540 illustrated in FIG. 15A has better control over the accuracy of the inductance and the greater convenience of the manufacturing process than the integrated magnetic core 1400 having the first material sections 1422a and 1422b formed at the side pillars illustrated in FIG. 14A.

Besides, for the windings of the magnetic cores, the first material sections bring diffusion of the magnetic field that results in the increase of the loss of the inductor windings. The distance to the first material sections is closer, the loss of the inductor windings is larger. Supposed that between FIG. 14A and FIG. 15A, the sizes are identical except that the first material sections of the magnetic core are different. When the vertical distance from the inductor winding 1420b to the first material section 1422b in FIG. 14A is Hw1, and the vertical distance from the inductor winding 1520b to the first material section 1522b in FIG. 15A is Hw2, it is obvious that Hw2>Hw1. As a result, the loss of the inductor windings in FIG. 15A is smaller.

The two shared magnetic cores in FIG. 15A can not only be expanded along the direction vertical to the horizontal dimension, but also can add one or more than one magnetic core units along the horizontal dimension. It is easy to perform expansion to three or more than three paths of shared magnetic cores.

FIG. 15C is a diagram of the integrated magnetic core 1500′ in an embodiment of the present invention. The integrated magnetic core 1500′ is the expansion of the integrated magnetic core 1500 in FIG. 15A and has three paths of shared magnetic cores that includes the magnetic core units 1500a-1500c and the corresponding windows and includes the corresponding inductor windings 1520a-1520c. The magnetic core units 1500a-1500c includes the first material sections 1522a-1522c respectively. The expansion along the horizontal dimension is very elastic and convenient. No addition adjustment during the fabrication of the whole magnetic core is needed. FIG. 15D is a diagram of the integrated magnetic core 1500″ in an embodiment of the present invention. The integrated magnetic core 1500″ is the mirror expansion on the basis of the integrated magnetic core 1500′ in FIG. 15C along the direction vertical to the horizontal dimension. The integrated magnetic core 1500″ has magnetic core units 1520a-1520f and the corresponding windows and includes the corresponding inductor windings 1520a-1520f. The magnetic core units 1500a-1500f includes the first material sections 1522a-1522f respectively. Every time the number of paths is doubled, only one polishing process is added. The fabrication process is relatively easier.

In addition, it needs to point out that when three or more than three paths of shared magnetic cores are expanded along the x dimension (taking the three paths illustrated in FIG. 15C as an example), the top cover is as shown in FIG. 15E. The length of the first material section 1522a of the magnetic core unit 1500a is D31, the length of the first material section 1522b of the magnetic core unit 1500b is D32 and the length of the first material section 1522c of the magnetic core unit 1500c is D33. The common design is to keep D31, D32 and D33 as identical as possible during fabrication. Under an ideal condition that the effect of the tolerance is neglected, it can be known from the symmetry of the structure that the inductances of the magnetic core units 1500a and 1500c are the same. Since the magnetic core unit 1500b is not completely symmetrical to them, the inductance Lb of the magnetic core unit 1500b is not identical with the inductance La of the magnetic core unit 1500a.

FIG. 15F is a diagram of a magnetic path model of the magnetic core unit 1500a in an embodiment of the present invention. The total reluctance Za is the total impedance from Port 1 (as illustrated in FIG. 15G). Similarly, FIG. 15H is a diagram of a magnetic path model of the magnetic core unit 1500b in an embodiment of the present invention. The total reluctance Zb is the total impedance from Port 2 (as illustrated in FIG. 15I). According to the relation of the parallel and serial connection of the magnetic path, Za is larger than Zb. The inductance of the magnetic core unit is inversely proportional to the total reluctance of the magnetic path. As a result, La<Lb, and Lb=(1+α)*La. Normally, the range of α is 0.1%˜10%. In the actual inductor specification, the inductors having the same size have an inductance bias of 10%. As a result, in common situations, the bias of the inductance La and Lb is acceptable. However, for the multi-path inductors connected in parallel and the inductors having higher requirement of the control of the inductance accuracy, the bias of the inductance needs to be modified. The practical method is to design the length D32 of the first material section 1522b of the magnetic core unit 1500b to be (1+α) times of the length D31 of the first material section 1522a of the magnetic core unit 1500a. As a result, in the embodiment of the integrated magnetic core 1500′ in FIG. 15C, the reluctance of the first material section 1522b of the magnetic core unit 1500b that has two neighboring magnetic core units is larger than the reluctance of the first material sections 1522a and 1522c of the magnetic core units 1500a and 1500c respectively that each of them has only one neighboring magnetic core unit. So on and so forth, in order to guarantee the balance of the inductance with the magnetic core units having less neighboring magnetic core units and the magnetic core units having more neighboring magnetic core units, the magnetic resistance of the first material sections in the magnetic core units having more neighboring magnetic core units may be designed to be larger than the reluctance of the first material sections in the magnetic core units having less neighboring magnetic core units. For example, a length of air gap (i.e. first material section 1522b in FIG. 15C) of magnetic core unit 1500b may be made longer than each of the lengths of air gaps (i.e. first material sections 1522a and 1522c) of magnetic core unit 1500a and 1500c, but the invention is not limited to this regard.

Surely, in other embodiments, the condition that the reluctance of the first material sections in one of the magnetic core units is larger than the reluctance of the first material sections in another one of the magnetic core units can be realized when the permeability of the material of the first material sections in one of the magnetic core units is smaller than the permeability of the material of the first material sections in another one of the magnetic core units.

The advantage of the present invention is to shrink the size of the multiple of integrated inductors by using the design of the integrated magnetic core.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An integrated magnetic core, integrated with a plurality of inductor windings to form a plurality of inductors comprising:
at least two windows, each having at least one of the inductor windings disposed therein; and
a plurality of magnetic core units, each having a closed geometrical structure to form one of the at least two windows, wherein two of the neighboring magnetic core units have a shared magnetic core part;
wherein the magnetic core units comprise at least two kinds of material having different magnetic permeability corresponding to different sections of the magnetic core units, wherein the reluctance of the shared magnetic core part is smaller than the reluctance of a non-shared magnetic core part of the magnetic core units.

2. The integrated magnetic core of claim 1, wherein the closed geometrical structure is a quadrangle, a triangle or a polygon, and axes of the at least two windows are parallel or vertical to each other.

3. The integrated magnetic core of claim 1, wherein a material of the shared magnetic core part is different from a material of the non-shared magnetic core part, and a permeability of the material of the shared magnetic core part is larger than a permeability of the material of the non-shared magnetic core part.

4. The integrated magnetic core of claim 1, wherein the non-shared magnetic core part comprises at least one first material section having a lowest permeability in the magnetic core units.

5. The integrated magnetic core of claim 4, wherein the permeability of the first material section is smaller than or equal to 50.

6. The integrated magnetic core of claim 4, wherein the number of the first material section is larger than one.

7. The integrated magnetic core of claim 6, wherein the first material section is disposed discretely or intensively at the non-shared magnetic core part of the magnetic core units.

8. The integrated magnetic core of claim 4, wherein the shared magnetic core part comprises a second material section, wherein the reluctance of the second material section is smaller than or equal to the reluctance of the first material section.

9. The integrated magnetic core of claim 4, wherein the magnetic core units comprises a magnetic core top cover and a magnetic core base, wherein the magnetic core top cover is disposed above the magnetic core base to form the closed geometrical structure.

10. The integrated magnetic core of claim 9, wherein the first material section is disposed at the magnetic core top cover.

11. An integrated inductor apparatus to integrate a plurality of inductors, wherein the integrated inductor apparatus comprises:
a plurality of inductor windings; and
an integrated magnetic core integrated with the inductor windings to form the inductors, wherein the integrated magnetic core comprises:
at least two windows each having at least one of the inductor windings disposed therein; and
a plurality of magnetic core units each having a closed geometrical structure to form one of the at least two windows, wherein two of the neighboring magnetic core units have a shared magnetic core part;
wherein the magnetic core units comprise at least two kinds of material having different magnetic permeability corresponding to different sections of the magnetic core units, wherein the reluctance of the shared magnetic core part is smaller than the reluctance of a non-shared magnetic core part of the magnetic core units.

12. The integrated inductor apparatus of claim 11, wherein a material of the shared magnetic core part is different from a material of the non-shared magnetic core part, and a permeability of the material of the shared magnetic core part is larger than a permeability of the material of the non-shared magnetic core part.

13. The integrated inductor apparatus of claim 11, wherein the non-shared magnetic core part comprises at least one first material section having a lowest permeability in the magnetic core units.

14. The integrated inductor apparatus of claim 13, wherein the shared magnetic core part comprises a second material section, wherein the reluctance of the second material section is smaller than or equal to the reluctance of the first material section.

15. The integrated inductor apparatus of claim 13, wherein the magnetic core units comprises a magnetic core top cover and a magnetic core base, wherein the magnetic core top cover is disposed above the magnetic core base to form the closed geometrical structure.

16. The integrated inductor apparatus of claim 15, wherein the first material section is disposed at the magnetic core top cover.

17. The integrated inductor apparatus of claim 15, wherein the reluctance of the first material section of one of the magnetic core units is larger than reluctance of the first material section of another one of the magnetic core units.

18. The integrated inductor apparatus of claim 13, wherein the reluctance of the first material section of the magnetic core units having two of the neighboring magnetic core units is larger than the reluctance of the first material section of the magnetic core units having only one of the neighboring magnetic core units.

19. The integrated inductor apparatus of claim 11, wherein the inductors are disposed in a switching mode power supply and are connected to a multi-path common input terminal or a multi-path common output terminal of the switching mode power supply.

20. The integrated inductor apparatus of claim 11, wherein current directions of the inductor windings are same and have a predetermined phase difference.
